(19) United States
(12) Patent Application Publication
(10) Pub. No.: US 2014/0226657 A1
(43) Pub. Date: Aug. 14, 2014

(54) METHOD OF EXCHANGING INFORMATION RELATING TO RICH COMMUNICATION SERVICES

(71) Applicant: ORANGE, Paris (FR)

(72) Inventor: Bertrand Bouvet, Perros Guirec (FR)

(21) Appl. No.: 14/351,547

(22) PCT Filed: Oct. 18, 2012
(86) PCT No.: PCT/FR2012/052380

§ 371 Date: Apr. 11, 2014

(30) Foreign Application Priority Data
Oct. 21, 2011 (FR) 1159547

(51) Int. Cl. H04L 29/06

(52) U.S. Cl. CPC H04L 65/60; H04L 65/1069
USPC 370/352

(57) ABSTRACT

Described is a method of exchanging information that is performed by a first device with a second device, both of which devices are registered with a voice over IP core network, the first device having placed a call over a circuit-switched network to a third device, said call actually being set up between the first device and the second device. In one embodiment, the method comprises:
receiving over the circuit-switched network a message confirming that the call has been set up with the second device, which message includes an identifier of the second device on the circuit-switched network; and
exchanging information with the second device via the core network and using the identifier of the second device, which information relates to the capacity of the first and/or second device to support at least one rich communication multimedia service.

### BACKGROUND OF THE INVENTION

The invention relates to the general field of telecommunications.

The invention relates more particularly to accessing multimedia services (known as “rich” communication services) via a voice over Internet protocol (VoIP) core network, in parallel with or at the margin of a call (communication) set up over a circuit-switched network between a first device and a second device, the call initially being made by the first device to a third device that is distinct from the second device and then being transferred to the second device.

The invention thus has a preferred application in the rich communication services-enhanced (RCS-e) standard developed by a consortium grouping together several telecommunications operators, and described in particular in the document entitled “RCS-e advanced communications: services and client specification”, version 1.1, Apr. 8, 2011.

In known manner, the RCS-e standard enables two terminals that are registered with an internet protocol (IP) multimedia subsystem (IMS) core network to set up a call via a circuit-switched network that is not connected to the IMS core network (e.g. via a global system for mobile communications (GSM) network), and then in parallel with or at the margin of said call, to use additional multimedia services via a packet switch network connected to the IMS core network, where such additional multimedia services are referred to as rich communication and comprise for example a service for transferring photographs, an instant messaging service, a file sharing service, etc.

For this purpose and in particular when creating a contact in the directory of a first terminal or when setting up a call between a first terminal and a second terminal, the RCS-e standard makes provision for the first terminal to use a mechanism of automatically discovering the RCE-e capacities (i.e. capabilities) of the second terminal (and vice versa), based on using an OPTIONS message in the session initiation protocol (SIP).

To illustrate that mechanism, consideration is given to two terminals A and B that are attached to a GSM network and that have RCS-e capacities (i.e. in compliance with the RCS-e standard and supporting at least one rich communication service that is proposed in the context of that standard).

The terminals A and B are also registered, via the SIP protocol, with an IMS core network managing the RCS-e services. In known manner, these registrations enable the IMS core network to know the address of contact AoCA of the terminal A, which comprises the IP address, the port number, and the transport protocol enabling the terminal A to be reached, and also the address of contact AoCB of the terminal B which comprises the IP address, the port number, and the transport protocol enabling the terminal B to be reached. The correspondence between the telephone number of the terminal A, or of the terminal B on the GSM network and the corresponding address of contact AoCA or AoCB of the terminal A or B is stored in the registration context, in the IMS core network.

It is now assumed that the terminal A sets up a telephone call with the terminal B over the GSM network. Once the call is established, since the both terminals are compatible with the RCS-e standard, they implement a mechanism of discovering their respective RCS-e capacities.

To do this, the terminal A exchanges information with the terminal B relating to their respective capacities for supporting rich communication services (referred to more simply as RCS-e services) in parallel with the call that has been set up.

More precisely, in accordance with the RCS-e standard:
the terminal A sends an SIP OPTIONS message to the terminal B, which message contains in particular, in its FROM header, the telephone number of the terminal A, and in its REQUEST URI and TO headers, the telephone number of the terminal B. The telephone number of the terminal B was obtained by the terminal A during the dialing operation that enabled the telephone call to be set up with the terminal B (e.g. on the basis of information contained in a contact card relating to the terminal B and contained in the directory of the terminal A); and
the terminal B sends an SIP OPTIONS message to the terminal A, containing in particular, in its FROM header, the telephone number of the terminal B, and in its REQUEST URI and TO headers, the telephone number of the terminal A. The telephone number of the terminal A is obtained by the terminal B during presentation of the telephone call: it is the caller number contained in the SETUP call signaling.

The SIP OPTIONS messages are conveyed to the IMS core network that, since it has the addresses of contact of the terminals A and B available, routes these SIP OPTIONS messages to their respective destinations.

On receiving the SIP OPTIONS message sent by the terminal B, the terminal A verifies that this message comes from the terminal having the number that was dialed in order to set up the call. Likewise, the terminal B verifies that the SIP OPTIONS message it receives from the terminal A does indeed come from the terminal having the number that was presented thereto in the SETUP call signaling.

In this example, since the terminals A and B are engaged in the same telephone conversation and since they are RCS-e compatible, each of them responds to the OPTIONS message it has received with an SIP 200OK response message, identifying the RCS-e services supported by each of them.

After the terminal A has received the 200OK message from the terminal B, it might for example activate a video sharing service with the terminal B.

It should be observed that the RCS-e standard makes provision for sending specific SIP response messages to the SIP OPTIONS message when the terminal B is not a terminal that is compatible with the RCS-e standard (e.g. the 404 NOT FOUND response message), or when the terminal B is compatible with the RCS-e standard but is not registered with the IMS core network at the time the terminal A sends the SIP OPTIONS message, e.g. because it is switched off or because it is outside network coverage (e.g. the response messages 480 TEMPORARILY UNAVAILABLE or 408 TIME-OUT).

In its present operation, the RCS-e standard does not make provision for accessing rich communication services when the telephone call placed by the terminal A is not set up with the terminal B but is transferred to another device C, such as another terminal compatible with the RCS-e standard.

Suppose for example that the terminal B is off, and has activated a call transfer service with its GSM network so that calls made to the terminal B are transferred to the terminal C. Once this transfer has been activated, the call made by the terminal A to the terminal B is actually set up with the terminal C. Since the terminals A and C are compatible with the RCS-e standard, once the call has been set up they trigger a mechanism for discovering their respective capacities as described above. In other words:
the terminal A sends to the terminal having the number it dialed, i.e. the terminal B, an SIP OPTIONS message. However, since the terminal B is not then registered with the IMS core network, a 480 TEMPORARILY UNAVAILABLE message is sent in response to the terminal A; and
the terminal C sends an SIP OPTIONS message to the terminal that is identified in the SETUP call signaling, i.e. to the terminal A. However, the terminal A does not recognize the number it dialed in the SIP OPTIONS message it receives so it responds with a 480 TEMPORARILY UNAVAILABLE message.

Consequently, although both of the terminals A and C are compatible with the RCS-e standard and although a call is indeed set up between these two terminals over the GSM network, it is not possible to access rich communication services in parallel with or at the margin of this call.

One solution to this failure might consist in triggering an application server in the IMS core network, which server is informed about calls made to the terminal B being transferred to the terminal C. The application server would then be configured to intercept the various messages exchanged between the terminals A and C and to modify the identifiers present in those messages so as to make the operation of the call transfer as activated by the terminal B transparent to both of the terminals. Nevertheless, that solution would be extremely complex to implement, since it would require the application server to have real-time information about the call transfers that are activated in the GSM network.

### OBJECT AND SUMMARY OF THE INVENTION

The invention serves in particular to mitigate the above-mentioned drawbacks by proposing a method of exchanging information that is performed by a first device with a second device, both of which are registered with a voice over IP (VoIP) core network. The method comprises:
a step of said first device making a call over a circuit-switched network to a third device;
a step of said call being set up between the first device and a second device that is distinct from the third device as a result of said call being transferred from the third device to the second device;
a step of the first device receiving over the circuit-switched network a message confirming call setup with the second device, this confirmation message including an identifier of the second device on the circuit-switched network; and
a step of the first device exchanging information with the second device via the voice over IP core network while using the identifier of the second device as contained in the confirmation message, this information relating to a capacity of the first and/or second device to support at least one multimedia service known as rich communication multimedia service.

Correspondingly, the invention also provides device referred to as “first” device that is registered with a voice over IP core network, the first device comprising:
means for making a call via a circuit-switched network to a third device;
means for setting up the call with a second device, distinct from the third device and registered with the voice over IP core network, as a result of said call to the third device being transferred to the second device;
receiver means for receiving over the circuit-switched network a message confirming that the call has been set up with the second device, this confirmation message including an identifier of the second device on the circuit-switched network; and
means for exchanging information with the second device via the voice over IP core network and suitable for using the identifier of the second device contained in the confirmation message, this information relating to the capacity of the first device and/or of the second device to support at least one multimedia service known as rich communication multimedia service.

It should be observed that in the meaning of the invention, an exchange of information performed by a first device with a second device means that information is transmitted from the first device to the second device and/or information is received by the first device from the second device.

Furthermore, in the meaning of the invention, the term “information relating to the capacity of a device to support at least one rich communication multimedia service” covers equally well information representative of the fact that the device supports a rich communication service at the margin of a call set up over the circuit-switched network, and information about the rich communication services supported by the device properly speaking (e.g. identifiers of supported services encoded in accordance with the RCS-e standard).

The invention thus proposes a method of the first device discovering the capacities of the second device with which the call is set up, which method is based not on the identifier on the circuit-switched network of the device called by the first device (i.e. the third device in the meaning of the invention), but on the identifier of the second device with which the call has actually been set up, which identifier is transmitted in a confirmation message sent over the circuit-switched network once the call has been set up.

The sending of such a confirmation message over a circuit-switched network is provided for in particular by the connected line presentation (COLP) service as described in the document ETS 300 094 published in January 1992 by the European telecommunications standards institute (ETSI) and entitled “Integrated services digital network (ISDN); connected line identification presentation (COLP) supplementary service; service description”. More precisely, in the context of the COLP service, the confirmation message is a CONNECT message that includes a “Connected Number” signaling field containing the identifier of the device on the circuit-switched network with which the call has been set up.

On the basis of information that has already been exchanged over the circuit-switched network (or at least on the basis of information for which there is provision to perform such an exchange), the invention thus makes it possible to gain access in simple manner to rich communication services via the voice over IP core network at the margin of or in parallel with a call set up over the circuit-switched network, with this applying even in the event of the call being transferred to a device distinct from its original destination.

In addition, the invention advantageously applies to any type of call transfer. The invention is applicable firstly regardless of the reason for call to the third device being transferred to the second device (e.g. the third device is not registered with the voice over IP core network, or lies outside the coverage of the network, or is already engaged in a call, etc.), and secondly independently of the specific device to which calls are transferred.

Thus, and in particular, the second device may be a terminal or it may be a server, e.g. such as a voice messaging server of the circuit-switched network or of a private automatic branch exchange (PABX), or any other type of communication server.

In similar manner, the invention applies to a first and third device of any kind: in particular, they may be terminals or servers.

In other words, and in general in the meaning of the invention, the term “a device” designates any type of equipment provided with means for communicating over a circuit-switched network and means for communicating via a VoIP core network VoIP. This equipment may be constituted by an entity grouping such communication means together or by a plurality of distinct entities fitted with distinct communication means and communicating with one another. Thus, by way of example, a “device” in the meaning of the invention may be constituted by equipment made up of a terminal having means for communicating over a circuit-switched network, such as a GSM telephone terminal, associated with a terminal having means for communication over a VoIP core network, such as an SIP multimedia tablet, with the terminal and the tablet exchanging information by means of a short-range wireless connection of the Bluetooth type (e.g. information such as the identifier received in the confirmation message).

The invention is thus particularly advantageous since situations in which calls are transferred from a device such as a terminal to some other device such as in particular a voice messaging server, occur quite frequently.

Providing rich communication services via a voice messaging server (which is not possible at present), and also exchanging multimedia data between the first device and the messaging server, is of considerable interest: it is possible to envisage that the first device, in parallel with leaving a voice message for the attention of the third device on the messaging server, also sends files for the attention of the third device, which files can be stored on the messaging server like the voice message. These files and the voice message can subsequently be consulted by the third device when it connects with the messaging server.

Preferably, the services identified in the response message of the second device are services compatible with the nature of the second device.

Specifically if the second device is a voice messaging server of the circuit-switched network, preference should be given to services enabling multimedia data to be deposited in order to be stored by the messaging server, for example transferring files, sharing photos or video, etc. In this way, the first device can leave multimedia data on the voice messaging server to which the third device can gain access on subsequently consulting the voice message from the first device as was stored when the call was set up with the second device.

In an implementation of the invention, the step of exchanging information in the method of the invention comprises:
the first device sending a message to the second device via the voice over IP core network by using the identifier contained in the confirmation message, which message seeks to discover the rich communication multimedia services that are supported by the second device; and
the first device receiving a response message from the second device via the voice over IP core network, the response message identifying the rich communication multimedia services that are supported by the second device, if any.

This enables the first device to activate rich communication services during the call set up with the second device, which services match the capacities of the second device.

In another implementation of the invention, the step of exchanging information comprises:
the first device receiving a message from the second device via the voice over IP core network seeking to discover the rich communication multimedia services that are supported by said first device;
the first device verifying that this message comes from the device identified in the call setup confirmation message; and
when the verification is positive, the first device sending a response message to the second device via the voice over IP core network, which response message identifies the rich communication multimedia services that are supported by the first device, if any.

In reciprocal manner, the second device with which the call is established is informed about the capacities of the first device. In addition, the verification performed by the first device makes it possible to be sure that the device originating the message is indeed the device with which the call has been set up.

In a particular implementation, the various steps of the information exchange method are determined by computer program instructions.

Consequently, the invention also provides a computer program on a data medium, the program being suitable for being performed by a device in accordance with the invention, or more generally by a computer, the program including instructions adapted to perform steps of an information exchange method as described above.

The program may use any programming language and may be in the form of source code, object code, or code intermediate between source code and object code, such as in a partially compiled form, or in any other desirable form.

The invention also provides a computer readable data medium including instructions of a computer program as mentioned above.

The data medium may be any kind of entity or device capable of storing the program. For example, the medium may comprise storage means, such as a read only memory (ROM), e.g. a compact disk (CD) ROM, or a microelectronic circuit ROM, or it may comprise magnetic recording means, e.g. a floppy disk or a hard disk.

Furthermore, the data medium may be a transmissible medium such as an electrical or optical signal suitable for being conveyed via an electrical or optical cable, by radio, or by other means. The program of the invention may in particular be downloaded from an Internet type network.

Alternatively, the data medium may be an integrated circuit in which the program is incorporated, the circuit being adapted to execute or to be used in the execution of the method in question.

In another aspect, the invention also provides a system comprising:
a first device in accordance with the invention and that is registered with a voice over IP core network; and
a second device that is registered with the voice over IP core network;

wherein the first device has made a call over a circuit-switched network to a third device that is distinct from the second device, and said call has been transferred to the second device and has been established with the second device.

The second device of the system of the invention may for example be a terminal or a voice messaging server of the circuit-switched network.

Thus, in another aspect, the invention provides a voice messaging server of a circuit-switched network, which server is registered with a voice over IP core network, said messaging server being suitable for performing rich communication multimedia services in parallel with or at the margin of a call set up over the circuit-switched network with a first device in accordance with the invention.

The system and the voice messaging server have the same advantages as those described above for the information exchange method of the invention.

In other embodiments and implementations, it is possible to envisage that the information exchange method, the device, the messaging server, and the system of the invention present in combination all or some of the above-mentioned characteristics.

### BRIEF DESCRIPTION OF THE DRAWINGS

Other characteristics and advantages of the present invention appear from the following description made with reference to the accompanying drawings which show an embodiment having no limiting character. In the figures:

FIG. 1 is a diagrammatic representation of a system and a device T1 in accordance with the invention in a particular embodiment;

FIG. 2 is a diagrammatic representation of the hardware architecture of the device T1 shown in FIG. 1, in a particular embodiment; and

FIG. 3 shows the main steps of an information exchange method in accordance with the invention in a particular implementation in which it is performed by the device T1 of FIG. 1.

### DETAILED DESCRIPTION OF AN EMBODIMENT

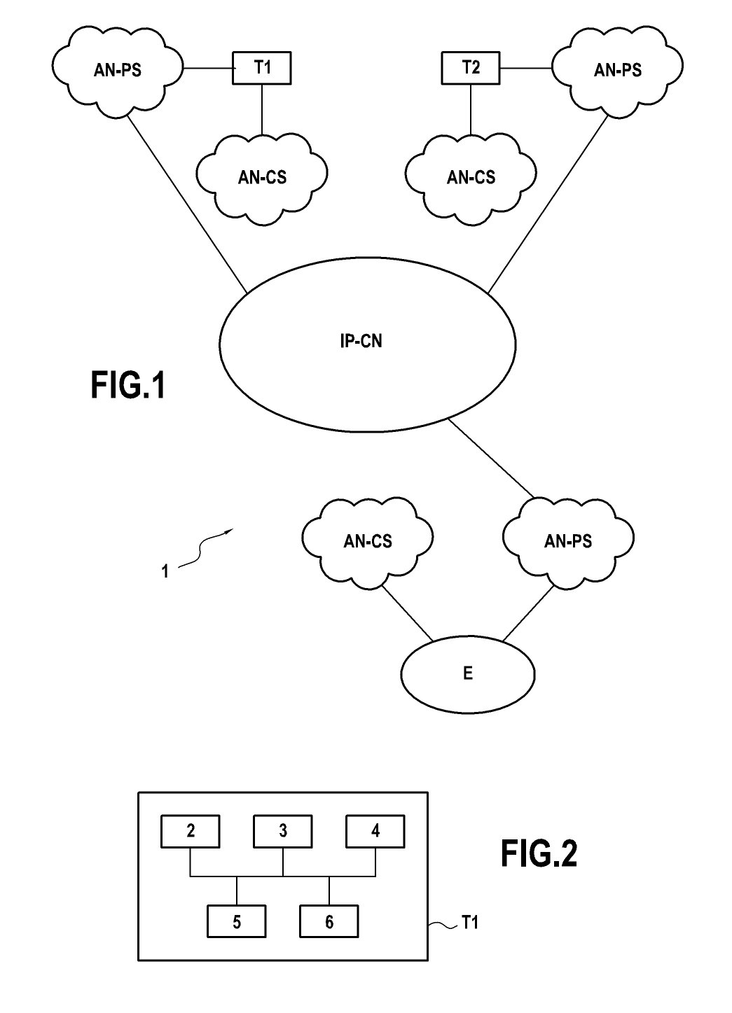

FIG. 1 shows a particular embodiment of a system 1 in accordance with the invention in its environment.

The system 1 is suitable for performing rich communication multimedia services via a packet switched access network (AN-PS) connected to a VoIP core network (IP-CN) in parallel with or at the margin of a telephone communication (i.e. telephone call) issued by a circuit-switched access network AN-CS that is not connected to the VoIP core network, with this applying even in situations in which the telephone call is transferred to a device E that is distinct from the initial destination of the call.

In the presently-described example, consideration is given more particularly to a call issued over the access network AN-CS by a terminal T1 in accordance with the invention to a terminal T2 that has activated call transfer to a device E (i.e. calls made to the terminal T1 are transferred to the device E). The invention is applicable independently of the criteria that have led to the call being transferred, so these criteria are not described in detail herein.

In other words, the terminal T1 is a first device in the meaning of the invention, the device E is a second device in the meaning of the invention, and the terminal T2 is a third device in the meaning of the invention.

Nevertheless, the invention applies to any device T1 and T2 suitable for communicating over the network AN-CS, such as for example servers such as PABX servers or any other type of call server.

In the presently-described embodiment, the VoIP core network IP-CN is an IMS core network, while the access network AN-CS is a GSM network, and the access network AN-PS is a universal mobile telecommunications system (UMTS) network. By way of example, the rich communication multimedia services are the services proposed in the context of the RCS-e standard and defined in the document entitled “RCS-e advanced communications: services and client specification”, version 1.1, Apr. 8, 2011.

Nevertheless, these assumptions are not limiting, and the invention is applicable to other VoIP core network architectures (e.g. H323, media gateway control protocol (MGCP), Peer2Peer), and also to other circuit-switched access networks (e.g. code division multiple access (CDMA)) or packet-switched access networks (e.g. high speed packet access (HSPA)).

Furthermore, the invention also applies when the terminal T1, the terminal T2, and/or the device E are connected to distinct IP core networks, possibly via access networks that are likewise distinct.

In accordance with the invention, the system 1 includes the terminal T1 and the device E, where T1 and E are suitable for setting up calls over the network AN-CS and for registering with the IMS core network IP-CN by using the SIP protocol, in conventional manner. By way of example, the device E may be a terminal or a server in accordance with the invention providing the network AN-CS with voice messaging and also having means for communication over the IMS core network.

In the presently-described embodiment, it is assumed that the connected line identification presentation (COLP) service as defined in ETSI document ETS 300 094 is available and activated on the network AN-CS for the terminal T1. In known manner, this service informs the maker of a call about the identity of the device with which the call is indeed set up, in particular via a CONNECT message. It is also assumed that the connected line restriction (COLR) service that makes it possible to oppose presentation by the circuit-switched network of the identifier of the line that has been reached to the calling terminal, is not activated for the device E (whether by the operator of the network AN-CS of the device E or by the user of the device E, or indeed by the user of the terminal T2, if the device E is a voice messaging server, etc.).

It is also assumed that the terminal T1 and the device E support one or more rich communication multimedia services as defined by the RCS-e standard, such as for example a multimedia file transfer service, a photo-sharing service, an instant messaging service, etc.

Naturally, the services supported by the terminal T1 and the device E depend on the natures and on the capacities of these devices (e.g. a mobile terminal, a laptop computer, a messaging server, etc.). Typically, when the device E is a voice messaging server, it will readily be understood that it is not suitable for supporting all types of service, and in particular services that require interaction in real time. In contrast, a voice messaging server can easily be configured so as to support services involving file storage or sharing videos with another device.

In the presently-described example, it should be observed that for simplification purposes, it is only T1 as the maker of a call over the network AN-CS to a terminal T2 that performs the information exchange method of the invention. Nevertheless, it should be understood that it is entirely possible to envisage the terminal T2 and the device E also performing the information exchange method of the invention and also being terminals in accordance with the invention.

The terminal T1 in this example has the hardware architecture of a computer, as shown diagrammatically in FIG. 2. In particular it comprises a processor 2, a random access memory (RAM) 3, a ROM 4, and communications means 5 for communicating over the circuit-switched network AN-CS, and communications means 6 for communicating over the packet-switched network AN-PS (incorporating in particular means for communicating using the SIP protocol), all of which are known.

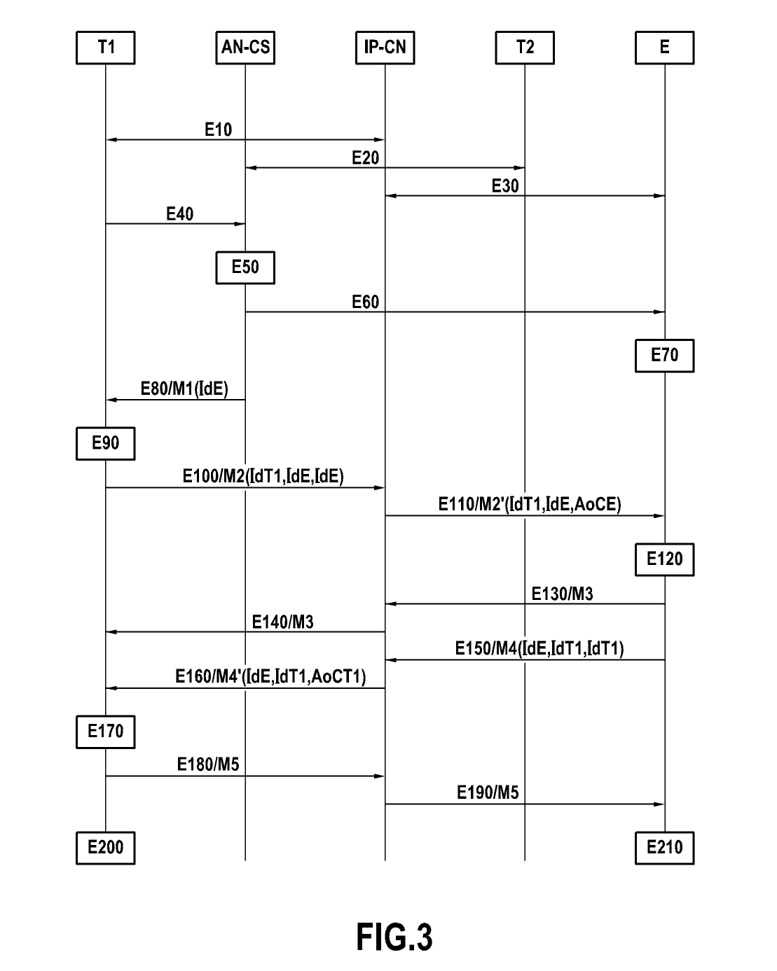

The ROM 4 of the terminal T1 constitutes a storage medium in accordance with the invention that is readable by the processor 2 and that has stored therein a computer program in accordance with the invention, including instructions for executing steps of an information exchange method in accordance with the invention, as described below with reference to FIG. 3.

It is assumed initially that the terminal T1 is switched on: after attaching itself to the network AN-CS (not shown in FIG. 1), T1 registers itself with the core network IP-CN in known manner using an SIP REGISTER message sent over the network AN-PS (step E10). This registration enables the core network IP-CN to know the address of contact (or reachability address) AoCT1 of the terminal T1, which address comprises in particular the IP address, the port number, and the reachability transport protocol of the terminal T1. In known manner, the match between this address of contact AoCT1 and an identifier IdT1 of the terminal T1 on the network AN-CS (i.e. telephone number) is stored in the registration context of the terminal T1 held by the core network IP-CN.

In parallel, it is assumed that the terminal T2 has activated call transfer with the network AN-CS for calls that are made to the terminal T2 over that network (step E20). Transfer may be effective in unconditional manner, or in a variant it may be effective on detecting certain criteria, such as for example failure of the terminal T2 to respond, in the event of the terminal T2 lying outside the coverage of the network AN-CS, in the event of the terminal T2 refusing the call, etc.

It is also assumed herein that the device E is switched on. The device E is permanently attached to the network AN-CS if it is a voice messaging server, or else it becomes attached each time it is switched on if it is a terminal (not shown in FIG. 1). The device E registers itself with the core network IP-CN with the help of an SIP REGISTER message sent over the network AN-PS (step E30). This registration enables the core network IP-CN to know the address of contact AoCE of the device E, which address comprises the IP address, the port number, and the reachability transport protocol of the device E. The correspondence between this address of contact AoCE and an identifier IdE of the device E on the AN-CS network (i.e. its telephone number) is stored in the registration context of the device E as held by the core network IP-CN.

It is now assumed that the terminal T1 makes a telephone call over the access network AN-CS to the terminal T2 (step E40), e.g. using its own telephone directory.

On detection of the transfer activated on the network AN-CS by the terminal T2 of calls that are made thereto (step E50), the call is routed by the network AN-CS to the device E (step E60).

It is assumed that the call is accepted by the device E (e.g. the user of the device E answers if it is terminal, or the call is taken automatically if it is a voice messaging server) (step E70). The call is then set up between the terminal T1 and the device E over the network AN-CS.

Once this call has been set up, and in accordance with the COLP service, the network AN-CS sends the identifier IdE of the device E to the terminal T1 over the network AN-CS in a call setup confirmation message E1 (step E80). In this example, the message M1 is a CONNECT message in compliance with the COLP service, including a “Connected Number” signaling field that contains the identifier IdE.

In addition, once the telephone call is established between the terminal T1 and the device E, the terminal and the device trigger a process of discovering their respective capacities (capabilities) concerning support for RCS-e rich communication services in parallel with or on the margin of (e.g. at the end of) the telephone call.

More precisely, on receiving the CONNECT message, the terminal T1 extracts the identifier IdE of the device with which the call has been set up from this message (step E90).

Thereafter, it exchanges information with the device E via the core network IP-CN and the network AN-PS, seeking to identify their respective capacities for supporting rich communication services (or conversely lack of support for RCS-e services). This information constitutes information about the capacity of the terminal T1 and/or of the device E to support at least one rich communication multimedia service that is handled by the core network IP-CN in the meaning of the invention.

For this purpose, the terminal T1 sends a message M2 over the network AN-PS to the device E by using the identifier IdE as extracted from the message M1 (step E100): the message M2 is an SIP OPTIONS message containing, in its header FROM, the identifier IdT1, and in its headers Request URI and TO, the identifier IdE. It seeks to discover the rich communication multimedia services handled by the core network IP-CN that are supported by the device E, if any.

The message M2 is transmitted to the core network IP-CN: the core network IP-CN knows the address of contact of the device E to which the message M2 is sent, and it routes this message in the form of a modified message M2′ to the device E (step E110). The message M2′ corresponds to the message M2 in which the identifier IdE present in the Request URI header has been replaced by the address of contact AoCE.

On receiving the message M2′, the device E, which also has the identifier IdT1 of the terminal T1 that made the call that has been set up over the network AN-CS (from the SETUP signaling sent to the device E while setting up the call), detects that the FROM header of the message M2′ also contains this identifier IdT1 (step E120). In other words, it detects that the identifier of the terminal present in the message M2′ does indeed designate the terminal with which a call has been set up over the network AN-CS.

Following this detection, the device E, which also supports RCS-e rich communication multimedia services responds favorably to the terminal T1 by sending a response message M3 to the terminal T1 via the network AN-PS (step E130). The message M3 is an SIP 200OK message containing the rich communication services supported by the device E (encoded specifically in compliance with the RCS-e standard), in other words, in this example, the RCS-e capacities of the device E.

In a variant, if the device E does not support RCS-e services, then the core network IP-CN sends an SIP 404 NOT FOUND response message M3 to the terminal T1. In similar manner, if the identifier extracted from the SETUP signaling does not correspond to the identifier received in the message M2′, the device E sends an SIP 480 TEMPORARILY UNAVAILABLE response message M3 to the terminal T1.

The response message M3 is routed to the terminal T1 via the network AN-PS and the core network IP-CN (step E140).

At its end, the device E extracts the identifier IdT1 of the terminal T1 on the network AN-CS from the SETUP message received while setting up the call with T1.

Thereafter it sends a message M4 over the network AN-PS to the terminal T1 using the identifier IdT1 extracted from the SETUP message (step E150): the message M4 is an SIP OPTIONS message containing in its FROM header the identifier IdE, and in its Request URI and TO headers the identifier IdT1. It seeks to discover the rich communication multimedia services handled by the core network IP-CN that are supported by the terminal T1.

The message M4 is transmitted to the IP-CN core network: since the core network IP-CN knows the address of contact of the terminal T1 to which the message M4 is being sent, it routes this message in the form of a modified message M4′ to the terminal T1 (step E160). The message M4′ corresponds to the message M4 in which the identifier IdT1 present in the Request URI header has been replaced by the address of contact AoCT1.

On receiving the message M4′, the terminal T1 verifies that the identifier IdE present in the FROM field of the message M4′ corresponds to the identifier IdE present in the CONNECT confirmation message (step E170). In other words, the terminal T1 verifies that the message M4′ does indeed come from the device E identified in the call setup confirmation message M1, i.e. the device with which the call is set up over the network AN-CS.

Where applicable, for a terminal T1 that also supports RCS-e rich communication multimedia services, the terminal T1 sends a favorable response message M5 to the device E via the network AN-PS (step E180). In this example, the message M5 is an SIP 200OK message containing the rich communication services that are supported by the terminal T1 (encoded specifically in accordance with the RCS-e standard), in other words, in this example, the RCS-e capacities of the terminal T1.

In a variant, if the terminal T1 does not support RCS-e services, the core network IP-CN sends an SIP 404 NOT FOUND response message M5 to the device E. In similar manner, if the identifier extracted from the CONNECT message does not correspond with the identifier received in the message M4′, the terminal T1 sends an SIP 480 TEMPORARILY UNAVAILABLE response message M5 to the device E.

This response message M5 is routed to the device E via the network AN-PS and via the core network IP-CN (step E190).

On receiving the 200OK messages, the terminal T1, or the device E as the case may be, acts via a man/machine interface to activate the RCS-e services that are compatible between the terminal T1 and the device E, in other words that are supported both by the terminal T1 and by the device E (steps E200 and E210). If one of the users of the terminal T1 and/or of the device E triggers a compatible RCS-e service, then an SIP session is established between the terminal T1 and the device E via the network AN-PS and the core network IP-CN in order to perform that service, as described in particular in the RCS-e standard.

It should be observed that the above description presents an implementation of the invention that may be applied to any device E (e.g. a terminal or a messaging server).

When the device E is a messaging server of the network AN-CS, and it proposes rich communication services over the core network IP-CN (in other words the messaging server E has means for communicating over the circuit-switched access network, over the packet-switched access network, and over the IMS core network), precedence is given, as described above, to services enabling multimedia data to be deposited for the purpose of being stored by the messaging server, such as for example file transfers, photo- or video-sharing, etc.

As a result, the terminal T1 may have available in parallel or at the margin of the telephone call (e.g. while recording a voice message), multimedia data (files, photos, videos, etc.) on the messaging server of the terminal T2 (i.e. on the device E) in the context of RCS-e services.

Later on, when the terminal T2 connects with its voice messaging server E in consultation mode in order to consult the voice message left by T1, it sets up a telephone call over the network AN-CS and performs the above-described procedure for discovering RCS-e capacities (exchanging SIP OPTIONS messages). Once the verifications have been performed, the voice messaging server E proposes sending to the terminal T2, the files, photos, and images that have been deposited by the terminal T1 in parallel with depositing the voice message.

Likewise, in parallel with or at the margin of the telephone call established between T1 and E, the messaging server E may propose sending to the terminal T1 files, video, and/or photos preconfigured for the terminal T1, or on the contrary defined generically for a set of terminals.

1. An information exchange method performed by a first device with a second device, said first and second devices both being registered with a voice over IP core network, said method comprising:
said first device making a call over a circuit-switched network to a third device;
setting up the call between the first device and a second device that is distinct from the third device as a result of said call being transferred from the third device to the second device;
receiving by the first device over the circuit-switched network a message confirming call setup with the second device, this confirmation message including an identifier of the second device on the circuit-switched network; and
said first device exchanging information with the second device via the voice over IP core network while using the identifier of the second device as contained in the confirmation message, this information relating to a capacity of the first and/or second device to support at least one multimedia service known as rich communication multimedia service.

2. An exchange method according to claim 1, wherein the process of exchanging information comprises:
the first device sending a message to the second device via the voice over IP core network by using the identifier contained in the confirmation message, which message seeks to discover the rich communication multimedia services that are supported by the second device; and
the first device receiving a response message from the second device via the voice over IP core network, the response message identifying the rich communication multimedia services that are supported by the second device, if any.

3. An exchange method according to claim 1, wherein the process of exchanging information comprises:
the first device receiving a message from the second device via the voice over IP core network seeking to discover the rich communication multimedia services that are supported by said first device;
the first device verifying that this message comes from the device identified in the call setup confirmation message; and
when the verification is positive, the first device sending a response message to the second device via the voice over IP core network, which response message identifies the rich communication multimedia services that are supported by the first device, if any.

4. An exchange method according to claim 1, wherein the confirmation message is a CONNECT message as defined by a connected line presentation service available for the first device on the circuit-switched network.

5. An exchange method according to claim 1, wherein the second device is a terminal or a voice messaging server of the circuit-switched network.

6. An exchange method according to claim 2, wherein the services identified in the response message of the second device are services compatible with the nature of the second device.

7. A computer program including instructions for executing steps of the exchange method according to claim 1 when said program is executed by a computer.

8. A non-transitory storage medium readable by a computer and having stored therein a computer program including instructions for executing steps of the exchange method of claim 1.

9. A device referred to as “first” device, registered with a voice over IP core network, said first device comprising:
a component configured to make a call via a circuit-switched network to a third device;
a component configured to set up the call with a second device, distinct from the third device and registered with the voice over IP core network, as a result of said call to the third device being transferred to the second device;
a receiver which receives over the circuit-switched network a message confirming that the call has been set up with the second device, this confirmation message including an identifier of the second device on the circuit-switched network; and
a component configured to exchange information with the second device via the voice over IP core network and suitable for using the identifier of the second device contained in the confirmation message, this information relating to the capacity of the first device and/or of the second device to support at least one multimedia service known as rich communication multimedia service.

10. A device according to claim 9, wherein said device comprises a terminal.

11. A system comprising:
a first device according to claim 9, and that is registered with a voice over IP core network; and
a second device that is registered with the voice over IP core network;
wherein said first device has made a call over a circuit-switched network to a third device that is distinct from the second device, and said call has been transferred to the second device and has been established with the second device.

12. A system according to claim 11, wherein the second device is a terminal or a voice messaging server of the circuit-switched network.

13. A voice messaging server of a circuit-switched network, which server is registered with a voice over IP core network, said messaging server being suitable for performing rich communication multimedia services in parallel with or at the margin of a call set up over the circuit-switched network with a device according to claim 9.

14. A device according to claim 9, wherein said device comprises:
a component configured to send a message to the second device via the voice over IP core network by using the identifier contained in the confirmation message, which message seeks to discover the rich communication multimedia services that are supported by the second device; and
a component configured to receive a response message from the second device via the voice over IP core network, which response message identifies the rich communication multimedia services that are supported by the second device, if any.

15. A device according to claim 9, wherein said device comprises:
a component configured to receive a message via the voice over IP core network from the second device, which message seeks to discover the rich communication multimedia services that are supported by said first device;
a component configured to verify that this message comes from the device identified in the call setup confirmation message; and
a component configured to be activated in the event of verification being positive for sending a response message to the second device via the voice over IP core network, which response message identifies the rich communication multimedia services that are supported by the first device, if any.
